(19) United States
(12) Patent Application Publication
(10) Pub. No.: US 2017/0327174 A1
(43) Pub. Date: Nov. 16, 2017

(54) Superefficient Box Beam Bicycle Structure

(71) Applicant: James D. Moore, Tujunga, CA (US)

(72) Inventor: James D. Moore, Tujunga, CA (US)

(21) Appl. No.: 15/153,424

(22) Filed: May 12, 2016

(51) Int. Cl. B62K 3/10; B62K 19/16

(52) U.S. Cl. CPC B62K 3/10; B62K 19/16

(57) ABSTRACT

A superefficient box beam bicycle structure (SBBBS) having a box section, a right triangular section and a left triangular section. The right and left triangular sections are either integral with the box structure, or the triangular sections are attached to the box structure by riveting, bonding or welding. The box structure is preferably made of a sheet material and the parts that comprise the box structure are attached together by riveting, bonding or welding. The SBBBS interfaces with conventional bicycle components to function as a lightweight, strong bicycle frame.

### TECHNICAL FIELD

The invention generally pertains to bicycles, and more particularly to a box beam structure that functions as a frame for various types of bicycles.

### BACKGROUND ART

Traveling from one location to another is one of the most important abilities of modern humans For a large part of mankind's history, people were born, lived and died in a single, usually small, geographical area. The reason for this was, and in some parts of the world still is, because of a lack of transportation. While the development of the automobile is responsible for people having the ability to travel, a bicycle is also a very important contributing factor to the ability for individual travel. For many people throughout the world, a bicycle is preferable over an automobile or other vehicle. Some people simply can not afford an automobile while others embrace the health benefits and lack of any environmental damage caused by a bicycle. Bicycles have also become popular as means of exercise and also used for sporting events such as racing or BMX competition.

A typical bicycle is designed with two wheels/tires that are attached to a frame. The most common appearance of a bicycle frame is multiple inter-connected tubes usually made of metal. his type of frame design has long been in use, although there are negative aspects and problems inherent to the design. One of the problems is that a tube frame can experience a significant orizontal or out of plane flexing which is strongly felt by a person riding the bicycle. Another problem is that the use of tubes, which are limited in diameter, can produce a frame with limited structural stiffness and integrity.

What is needed is a bicycle frame that has greater torsional stiffness and fatigue life with approximately comparable vertical or in-plane stiffness as conventional tube frames. A beneficial alternative to a tube frame is a box beam frame which has equal mass and significantly greater structural benefits. A box beam frame does not experience the same level of flexing a tube frame. Further, the structural components of a box beam frame made of sheet material are low in cost, higher in strength, available in more alloys and are easily cut and formed. The components are readily attached together by strong and secure attachment means such as rivets, bonding or welding.

A box beam frame would offer solutions to many of the problems associated with a conventional tube frame, without presenting any new problems or deficiencies. The design is readily adaptable to any frame type including road, track, BMX, mountain and recreational use.

A search of the prior art did not disclose any literature or patents that read directly on the claims of the instant invention. However, the following U.S. patents are considered related:

| PATENT NO. | INVENTOR | ISSUED |
|---|---|---|
| Re. 33,295 | Trimble | Aug. 14, 1990 |
| 5,255,932 | Moore | Oct. 26, 1993 |
| 4,548,422 | Michel, et al | Oct. 22, 1985 |

The Re. 33,295 patent discloses a bicycle frame with a structural support that provided by a formed, stressed skin in conjunction with integral tubes and stiffening ribs. A body is formed which joins the front fork, pedal axle, seat post and rear wheel axle. The body is visually solid from the side with two open triangles of a conventional tube frame being filled in, and is airfoil shaped from the top. All control cables, and a cargo compartment, are contained within the frame.

The U.S. Pat. No. 5,255,932 patent discloses a superefficient bicycle frame having a plurality of dual tapered rectangular or square cross section frame members. A torsional-bending section modulus of a member is changed by providing a dual taper to the cross section of the frame members so that larger cross sections are used at points of greatest stress and smaller cross sections are used at points of lower stress. The method of manufacture is to cut various two dimensional shapes form sheet stock which are bent along nonparallel shapes from sheet stock which are bent along nonparallel bend lines to form the various members.

The U.S. Pat. No. 4,548,422 patent discloses a bicycle frame having a shell structure consisting of two assembled shells. Each shell has the axis of a passage of a seat shaft combined with the axis of a housing of a crank gear in the plane of assembly.

For background purposes and indicative of the art to which the invention relates, reference may be made to the following remaining patents found in the patent search.

| PATENT NO. | INVENTOR | ISSUED |
|---|---|---|
| 4,230,332 | Porsche | Feb. 14, 1997 |
| 3,375,024 | George | Feb. 8, 1966 |
| 2,855,20 | Douglas, et al | Jun. 20, 1957 |
| 5,470,092 | Fardy | Nov. 28, 1995 |

### DISCLOSURE OF THE INVENTION

In a basic design, the superefficient box beam bicycle structure (SBBBS) is comprised of a front box section with a right side, a left side, an upper section/closeout, a lower section/closeout, a front end and a rear end; a right rear triangular section with an outer surface, an inner surface, an upper edge, a lower edge; connected to seat tube, the rear dropout and front box section; and a left rear triangular section with an outer surface, an inner surface, an upper edge, a lower edge, a front end and a rear end connected to a seat tube, rear dropout and front box section. The box section and the two triangular sections can either be integral, or the two rear triangular sections can be attached to the seat tube and front box section by riveting, bonding or welding. The sides, sections and ends of the box section can also be attached together by riveting, bonding or welding.

There are channels and openings that facilitate the interfacing of conventional bicycle components including a head tube, a lower bracket, a right dropout and a left dropout. The SBBBS works in combination with the conventional bicycle components to function as a frame for a bicycle.

In an alternate design, flanges are utilized to allow the riveting, bonding or welding of the SBBBS various parts together. In both designs, openings can be utilized for weight reduction, and a core material can be placed within the box section to increase structural integrity and to reduce vibrations that can be felt through the SBBBS. Additionally, gussets can be placed at locations of higher stress.

In view of the above disclosure, the primary object of the invention is to produce a superefficient box beam bicycle structure that functions as a modern, state-of-the-art bicycle frame.

In addition to the primary object, it is also an object of the invention to produce a superefficient box beam bicycle structure that:
can be used with any type of bicycle,
is lightweight,
is significantly less flexible than conventional tube-structure bicycle frames,
is easy to use,
can be made of more alloys and other materials than a tube frame,
can be made in various sizes,
can be used in competitive bicycling events, and
is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPION OF THE DRAWINGS

FIG. 1 is an orthographic side view of a superefficient box beam bicycle structure (SBBBS) utilizing an attachment means comprising riveting.

FIG. 2 is an orthographic side view of a SBBBS utilizing an attachment means comprising bonding.

FIG. 3 is an orthographic side view of a SBBBS utilizing an attachment means comprising welding.

FIG. 4 is an orthographic side view of the SBBBS showing two triangular sections that are attached to a box structure.

FIG. 5 is an exploded orthographic side view of an alternate design of the SBBBS.

FIG. 6 is an orthographic side view of the SBBBS in place, and function as, a frame for a bicycle.

### BEST MODE FOR CARRYING OUT THE INVENTION

The best mode for carrying out the invention is presented in terms that disclose a preferred embodiment with multiple design configurations of a superefficient box beam bicycle structure (SBBBS). One of the most important components of a bicycle is the frame. The frame is a major contributor to the experience of riding a bicycle.

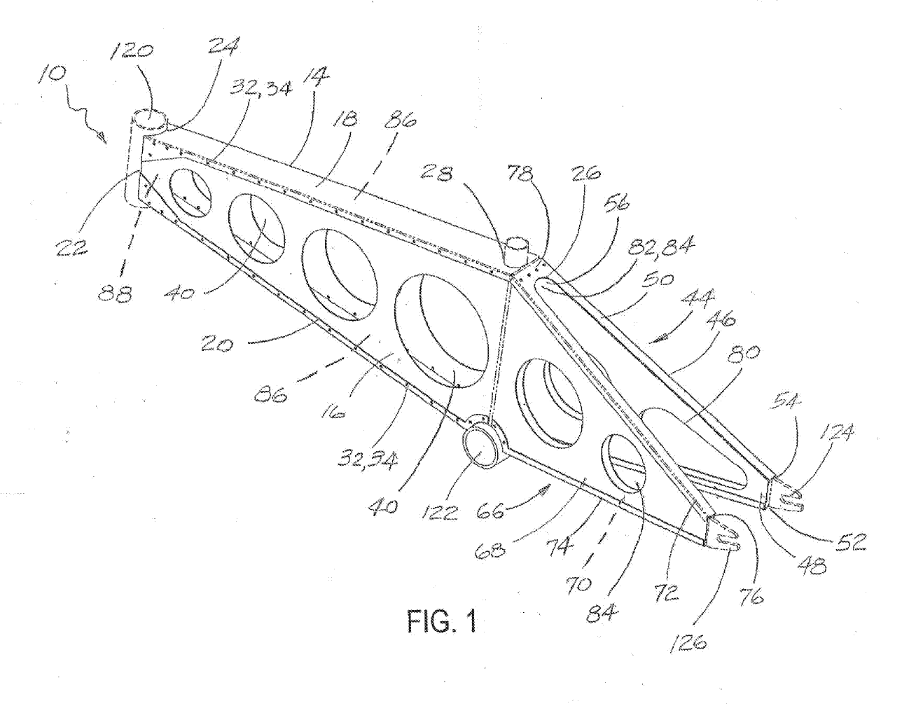

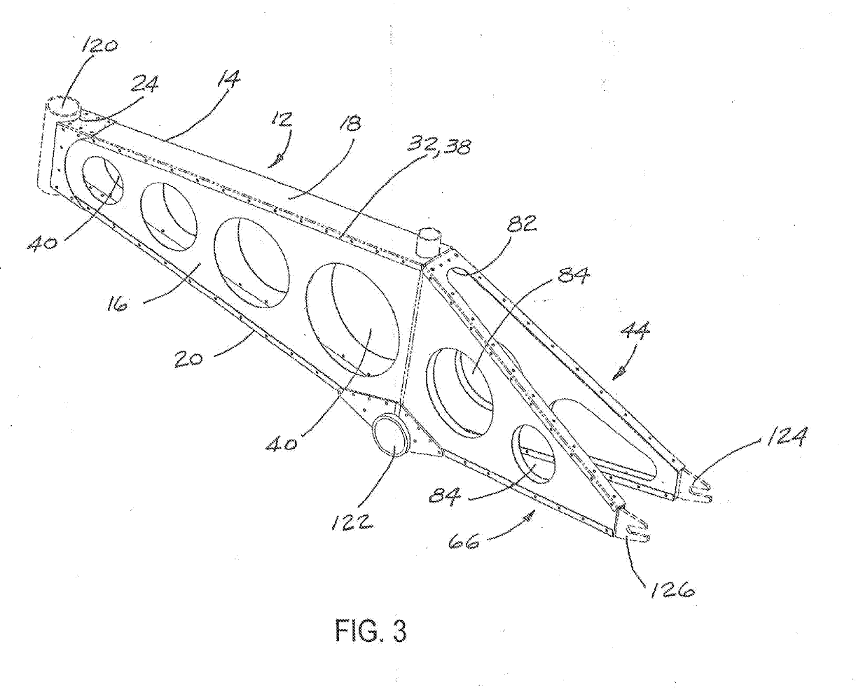

Typically, a bicycle frame is constructed from multiple metal tubes that are welded together. While functionality adequate, a tube frame has limited structural integrity and can be prone to vibrations that are transferred to, and felt by, a rider of a bicycle. The SBBBS 10, as shown in FIGS. 1-6, functions as a bicycle frame with improved structural integrity and that reduces the amount of vibrations.

There are three main inventive concepts/improvements to the SBBBS 10: first is the design of the SBBBS 10, second is the preferred use of a sheet material to construct the SBBBS 10, and third is the manufacturing process which utilizes riveting, bonding or welding together of the various components of the SBBBS 10.

As shown in FIGS. 1-6, the SBBBS 10 is comprised of three major elements: a box structure 12, a right triangular section 44, and a left triangular section 66. The box structure can be either a single-wall or double-wall construction.

The box structure 12, as shown in FIGS. 1-4 and 6, includes a right side section 14, a left side section 16, an upper section 18, a lower section 20, a front end 22 having a vertical semi-circular channel 24, and a rear end 26 having a horizontal semi-circular channel 28. The box structure 12 is substantially rectangular shaped, with the upper section 18 tapering downward toward the front end 22, and the lower section 20 tapering upward toward the front end 22.

The right triangular section 44, as shown in FIGS. 1-4, includes an outer surface 46, an inner surface 48, an upper edge 50, a lower edge 52, a front end 54, and a rear end 56. The right triangular section 44 extends rearward and slightly flares outward from the rear end 24 of the box structure 12, with the triangular section's upper edge 50 tapering downward, and the lower edge 52 tapering upward.

The left triangular section 66, as shown in FIGS. 1-4, is essentially a replica of the right triangular section 44 and also includes an outer surface 68, an inner surface 70, and upper edge 72, a lower edge 74, a front end 76, and a rear end 78. The left triangular section 66 extends rearward and slightly flares outward from the rear end 26 of the box structure 12, with the triangular section's upper edge 72 tapering downward, and the lower edge 74 tapering upward. The two triangular sections 44,66 have a space between them, and at a location where the respective front ends 54,76 of the triangular sections interface with the rear end 26 of the box structures 12, a vertical U-shaped channel 82, as shown in FIGS. 1-4, is formed.

As shown in FIGS. 1-4, the vertical semi-circular channel 24 at the box structure's front end 22 interfaces with a conventional bicycle head tube 120, the horizontal semi-circular channel 28 located on the lower section 20 adjacent the box structure's rear end 26 interfaces with a conventional bicycle lower/seat bracket 122. The right triangular section's rear end 56 interfaces with a conventional bicycle right dropout 124, and the left triangular section's rear end 78 interfaces with a conventional bicycle left dropout 126. In combination with the interfacing of the conventional bicycle components, the SBBBS 10 functions as a frame for a bicycle.

The SBBBS 10 is made of a material selected from the group consisting of a sheet material, carbon fiber, fiberglass, plastic or a composite material. The sheet material can be aluminum alloy, a metal matrix composite, titanium, a fiber reinforced polymer, a ferrous alloy, magnesium alloy, or a honeycomb material. The multiple sections that comprise the box structure 12 are attached together by an attachment means 32 that consists of riveting 34, bonding 36 or welding 38.

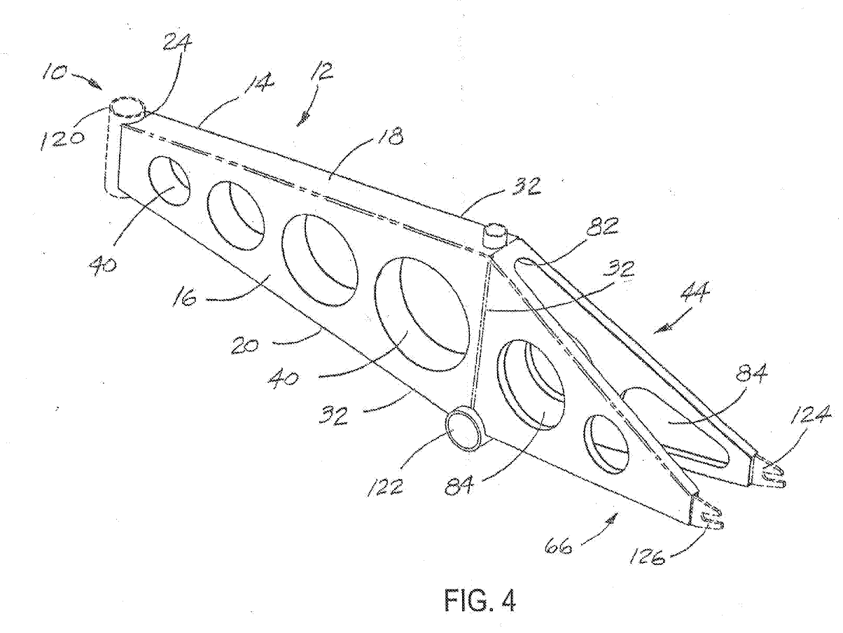

The box structure 12 and the two triangular sections 44,66 can be either integrally attached, as shown in FIGS. 1-3, or the triangular sections 44,66 can be attached to the box structure 12, as shown in FIG. 4, by the attachment means 32 consisting of riveting 34, bonding 36 or welding 38. The use of these three attachment means for a box structure bicycle frame is one of the inventive elements that significantly differentiates the SBBBS 10 from conventional, prior art bicycle frames. It is important to note the capability of utilizing a weld-able sheet material that is riveted to, or riveted and bonded to, other not readily weld-able material(s). This also a main inventive concept of the SBBBS 10.

To add to the functional capability of the SBBBS 10, at least one opening 40 and 84, as shown in FIGS. 1-5, can be placed on either, both, or all of the box structure 12, the right triangular section 44 and/or the left triangular section 66. The at least one opening 40 and 84 can be any geometric or non-geometric shape, and is utilized to provide weight reduction to the SBBBS 10. Additionally, a chain slot 80, as shown in FIG. 1, can be placed on either triangular section 44,66.

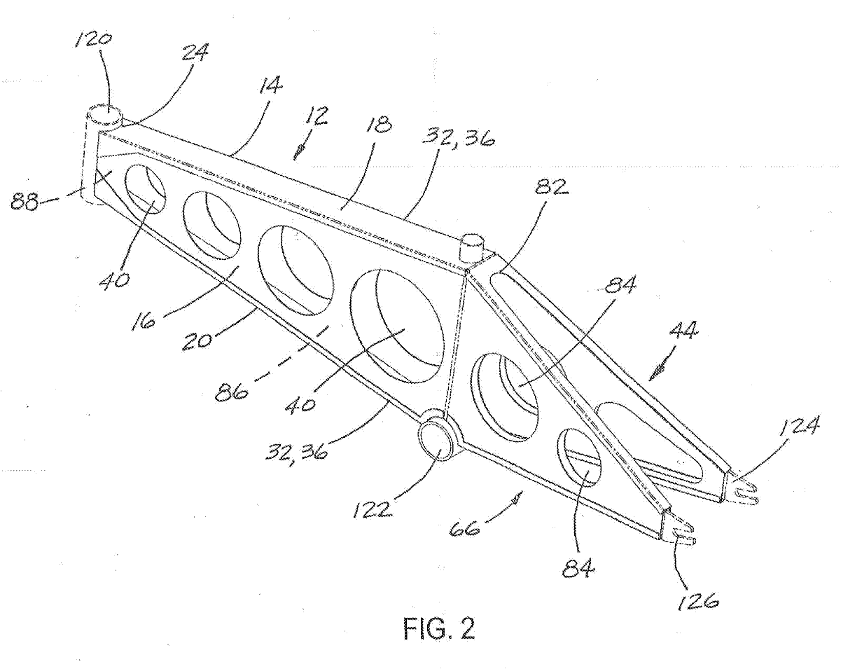

As shown in FIGS. 1 and 2, located within the box structure 12 can be a quantity of core material 86 that increases the rigidity of the SBBBS 10. The core material is preferably a lightweight bondable material, such as a honeycomb material, rigid foam, a composite fiber material, or balsa wood.

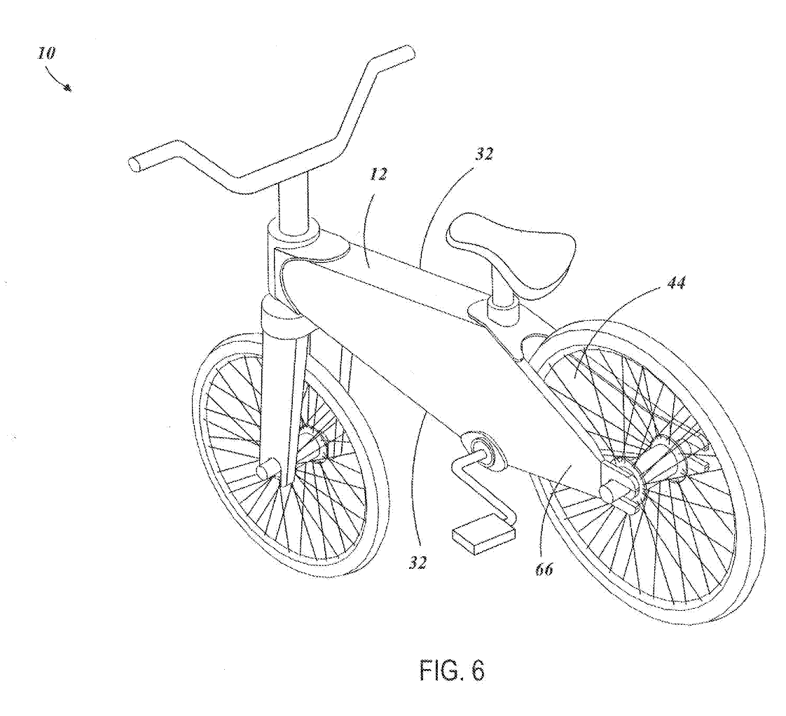

In areas/locations of higher stress, such as the interfaces of the head tube bracket, seat tube or lower bracket, at least one gusset 88, as shown in FIG. 6, can be added to provide additional strength, stiffness and structural integrity.

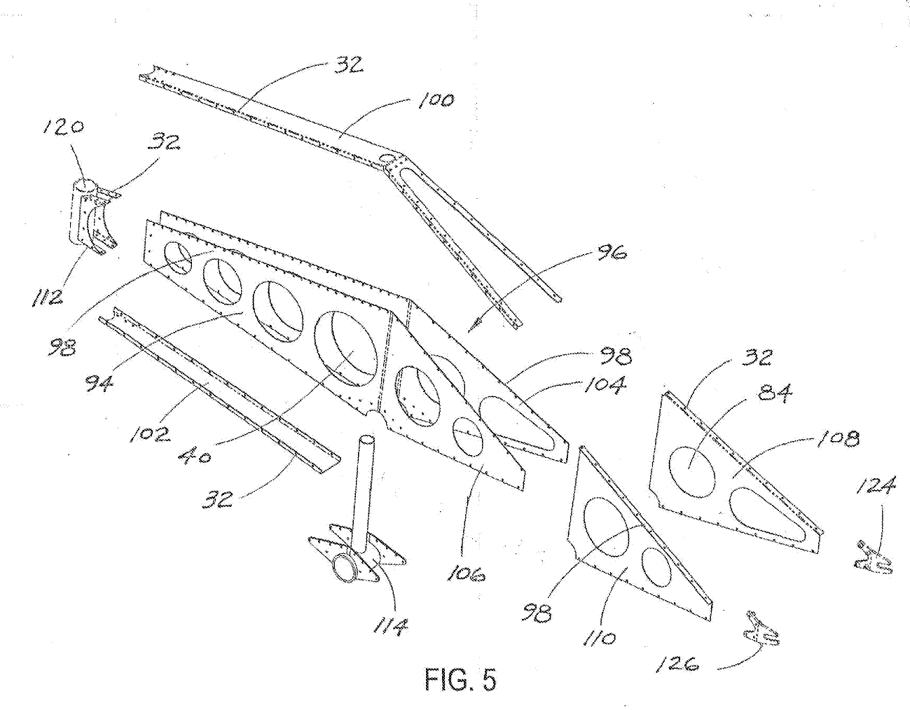

An alternate design of the preferred embodiment of the SBBBS 10 comprises a geometric structure 92 with a right section 94 and a left section 96, as shown in FIG. 5. The right section 94 comprises a front substantially triangular shape with a front extending taper, and a rear substantially triangular shape with a rear extending taper. The left section 96 is a mirror image of the right section 94. Located along edges of the structure 92 are flanges 98 for facilitating attachment of the two sections together. The rear triangular shapes flare outward, thereby creating a space between the two rear triangular shapes. An upper closeout 100 is attached by an attachment means to upper edges of the left and right front triangular shapes, and a lower closeout 102 is attached by the attachment means 32 to lower edges of the left and right triangular shapes. When the upper and lower closeouts 100,102 are attached, a box structure is created of the two front triangular shapes. Attached to an inner surface of the right rear triangular shape 104 is a right inner triangular section 108, and attached to an inner surface of the left rear triangular shape 106 is a left inner triangular section 110. When the two inner triangular sections 108,110 are attached, two independent triangular shaped structures are created, each of which extends rearward and outward from the front triangular structure. A front end of the front structure interfaces with a head tube bracket 112 that is attached to the front end by the attachment means 32, as shown in FIG. 5. Located substantially where the two rear triangular structures meet the front triangular box structure is an interface with a lower bracket 122 and seatpost 114, with the seatpost extending upward through openings on the lower surface and upper surface/upper closeout. Extending rearward from the right rear triangular structure is a right dropout 124, and extending rearward from the left rear triangular structure is a left dropout 126. The alternate design of the SBBBS 10 is also utilized in combination with bicycle components to function as a frame for a bicycle.

It should be noted, that the materials and attachment means disclosed herein are only predominant examples. There are other current materials and attachment means, as well as yet not developed materials and attachment means, that could be utilized and function with equal efficacy.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. A superefficient box beam bicycle structure (SBBBS) comprising a front box structure and two triangular sections angularly extending outward from a rear end of said box structure, wherein said SBBBS interconnects with multiple conventional bicycle components to form a bicycle frame.

2. The SBBBS as specified in claim I wherein said SBBBS is made of a material selected from the group consisting of a sheet material, carbon fiber, fiberglass, plastic or a composite material.

3. The SBBBS as specified in claim 2 wherein said sheet material is selected from the group consisting of aluminum alloy, a metal matrix composite, titanium, fiber reinforced polymer, ferrous alloy, magnesium alloy, or a honeycomb material.

4. The SBBBS as specified in claim 1 wherein said box structure and said two triangular sections are integral.

5. The SBBBS as specified in claim 1 wherein said two triangular sections are attached by attachment means to said box structure.

6. The SBBBS as specified in claim 5 wherein said attachment means are selected from the group consisting of riveting, bonding or welding.

7. The SBBBS as specified in claim 1 wherein said box structure and said two triangular sections further comprise at least one weight reducing opening.

8. A superefficient box beam bicycle structure comprising:
a) a box structure including a right side section, a left side section, an upper section, a lower section, a front end having a vertical semi-circular channel, and a rear end having a horizontal semi-circular channel, wherein said box structure has a substantially rectangular shape having an upper section tapering downward toward the front end, and the lower section tapering upward toward the front end,
b) a right triangular section including an outer surface, an inner surface, a downward tapering upper edge, a lower edge, a front end, and a rear end, wherein said right triangular section extends rearward and outward from the rear end of said box structure, with said triangular section's upper edge tapering downward, and the lower edge tapering upward, and
c) a left triangular section including an outer surface, an inner surface, an upper edge, a lower edge, a front end, and a rear end, wherein said left triangular section extends rearward and outward from the rear end of said box structure, with said triangular section's upper edge tapering downward, and the lower edge tapering upward, wherein said two triangular sections having a space therebetween and at the location where the respective front ends of said triangular sections interface with the rear end of said box structure, a vertical U-shaped channel is formed, wherein the vertical semi-circular channel at said box structure's front end interfaces with a conventional bicycle head tube, the horizontal semi-circular channel located on the lower section adjacent said box structure's rear end interfaces with a conventional bicycle lower/seat bracket, the right triangular section's rear end interfaces with a conventional bicycle right dropout, and the left triangular section's rear end interfaces with a conventional bicycle left dropout, wherein in combination with the interfacing of the conventional bicycle components, said SBBBS functions as a frame for a bicycle.

9. The SBBBS as specified in claim 8 wherein said SBBBS is made of a material selected from the group consisting of a sheet material, carbon fiber, fiberglass, plastic or a composite material.

10. The SBBBS as specified in claim 9 wherein said sheet material is selected from the group consisting of aluminum alloy, a metal matrix composite, titanium, a fiber reinforced polymer, a ferrous alloy, a magnesium alloy, or a honeycomb material.

11. The SBBBS as specified in claim 8 wherein the sections of said box structure are attached together by an attachment means selected from the group consisting of riveting, bonding or welding.

12. The SBBBS as specified in claim 8 wherein said box structure and said two triangular sections are integral.

13. The SBBBS as specified in claim 8 wherein said two triangular sections are attached by attachment means to said box structure.

14. The SBBBS as specified in claim 13 wherein the attachment means are selected from the group consisting of riveting, bonding or welding.

15. The SBBBS as specified in claim 8 wherein said box structure further comprises at least one weight reducing opening.

16. The SBBBS as specified in claim 8 wherein said right triangular section and said left triangular section further comprise at least one weight reducing opening, and one chain slot.

17. The SBBBS as specified in claim 8 wherein said box structure further comprises a core material that is located within said structure, and that increases the rigidity of said SBBBS.

18. The SBBBS as specified in claim 17 wherein the core material is selected from the group consisting of a honeycomb material, rigid foam, a composite fiber material, or balsa wood.

19. The SBBBS as specified in claim 8 further comprising at least one gusset at locations of higher stress.

20. A superefficient box beam bicycle structure comprising a geometric structure with a right section and a left section, wherein said right section comprises a front substantially triangular shape with a front extending taper, and a rear substantially triangular shape with a rear extending taper, wherein said left section is a mirror image of said right section, wherein located along edges of said structure are flanges for facilitating attachment of the two sections together, wherein said rear triangular shapes flare outward, thereby creating a space between the two rear triangular shapes, wherein an upper closeout is attached by an attachment means to the upper edges of said left and right front triangular shapes, and a lower closeout is attached by the attachment means to the lower edges of said left and right triangular shapes, wherein when the upper and lower closeouts are attached, a box structure is created of the two front triangular shapes, wherein attached to an inner surface of said right rear triangular shape is a right inner triangular section, and attached to an inner surface of said left triangular shape is a left inner triangular section, wherein when the two inner triangular sections are attached, two independent triangular shaped structures are created, each of which extends rearward an outward from said front triangular structure, wherein a front cnd of said front structure interfaces with a head tube bracket that is attached to the front end by the attachment means, wherein located substantially where said the two rear triangular structures meet the front triangular box structure is an interface with a lower bracket and seat tube, with the seat tube extending upward through openings on the lower surface and upper surface/upper closeout, wherein extending rearward from the right rear triangular structure is a right dropout, and extending rearward from the left rear triangular structure is a left dropout, wherein the SBBBS is utilized in combination with bicycle components to function as a frame for a bicycle.

21. The SBBBS as specified in claim 20 wherein the attachment means are selected from the group consisting of riveting, bonding or welding.
